(19) United States
(12) Patent Application Publication
(10) Pub. No.: US 2017/0199862 A1
(43) Pub. Date: Jul. 13, 2017

(54) Systems and Methods for Creating an N-dimensional Model Table in a Spreadsheet

(71) Applicant: Steve Litt, Glen Rock, NJ (US)

(72) Inventor: Steve Litt, Glen Rock, NJ (US)

(21) Appl. No.: 15/320,781

(22) PCT Filed: Jul. 9, 2015
(86) PCT No.: PCT/US15/39808

§ 371 Date: Dec. 21, 2016

Related U.S. Application Data
(60) Provisional application No. 62/023,084, filed on Jul. 10, 2014.

(51) Int. Cl. G06F 17/24

(52) U.S. Cl. CPC G06F 17/246; G06F 17/245

(57) ABSTRACT

Systems and methods are provided to for automatically generating an N dimensional model table in a spreadsheet program. A model table function or add-in is executed as part of a spreadsheet program. More than two selections of one or more rows or columns from two or more tables of the spreadsheet program are received from a pointing and selection device. Each selection represents a different data dimension of more than two different data dimensions of the two or more tables. A model table is generated in the spreadsheet program from the more than two different data dimensions selected from the two or more tables by automatically repeating the elements of at least one data dimension of the more than two different data dimensions.

### CROSS REFERENCE TO RELATED APPLICATION

This application claims the benefit of U.S. Provisional Patent Application Ser. No. 62/023,084, filed Jul. 10, 2014, the content of all of which is incorporated by reference herein in its entirety.

### INTRODUCTION

Wikipedia as of Jul. 5, 2015 defined a spreadsheet as an interactive computer application program for organization, analysis, and storage of data in tabular form. https://en.wikipedia.org/wiki/Spreadsheet. Current spreadsheets include, but are not limited to, Excel 2013 by Microsoft, cloud and on-line spreadsheets like Sheets by Google, spreadsheet objects and in-memory spreadsheets. A spreadsheet consists of a. two-dimensional array of cells in which information of various data types is stored. Information is typically organized in spreadsheets in tables.

A table is defined herein as a collection of one or more contiguous cells where each of the one or more contiguous cells is indexable by one or more contiguous cell rows and one or more contiguous cell columns. A single cell with information of a particular data type is, for example, a table. The single cell is indexable by one row and one column, in one worksheet and one workbook, for example.

FIG. 1 is an exemplary screenshot 100 of an Excel 2013 spreadsheet that includes a table 110 showing test scores of a number of tests for a number of students. Table 110 is a collection of 20 contiguous cells B2 through F6. Each of the 20 contiguous cells B2 through F6 is indexable by contiguous cell rows 2 through 6 and contiguous cell columns B through F.

Table 110 includes two types of information. Table 110 includes data dimension or index information and data information. Data dimension information as used herein is row or column information that specifies the data of a data dimension or index. For example, column B of table 110 includes data dimension information for a first data dimension of table 110. The data dimension or index information in column B is the different students. The data of the data dimension for students is the labels Student1, Student2, Student3, and Total Students. Row 2 of table 110 includes data dimension information for a second data dimension of table 110. The data dimension or index information in row 2 is the different tests administered. The data of the data dimension for tests administered is the labels Test1, Test2, Test3, and, All Tests.

The data of table 110 is shown in rows 3 through 6 and columns C through F. The data is of two types. The data in rows 3 through 5 and columns C through E is test score values. The data in row 6 and columns C through F is an average of the scores in the preceding three rows, and the data in column F and rows 3 through 6 is an average of the scores in the preceding three columns. In other words, the data shown in Table 110 is either a value or a formula.

Table 110 is typical of many of the tables stored in spreadsheets. It includes two data dimensions that take advantage of the space saving of the two-dimensional organization of cells. However, it is also typical that spreadsheets contain two or more tables with two data dimensions and that data of these two or more tables are related. In other words, spreadsheets typically include two or more tables with two data dimensions that describe data with more than two data dimensions.

For example, FIG. 1 shows that table 110 is part of sheet 123 call Class3. So table 110 represents the scores for Class3. Classes Class1 and Class2 on sheets 121 and 122, respectively, can include tables like table 110 for the scores of the same students in table 110 for the same number of tests, for example. The data in the three tables for the three different classes would then have three data dimensions. The three data dimensions are students, tests, and classes.

Further as shown in FIG. 1, sheet 123 also includes in cell A1 the specification of Spring Semester and in cell A2 the specification of Yr_2015. There each of sheets 121, 122, and 123 can include tables like table 110 for each semester of each year for series of years. In other words, the data in all the tables in the three sheets 121, 122, and 123 could encompass five data dimensions. The five data dimensions could be Students, Tests, Classes, Semesters, and Accts(Score, GPA, and Grade).

In this way, data of related N data dimensions is typically stored in spreadsheets. Often it is of value to analyze this data in different ways taking advantage of the related N data dimensions. For example, table 110 of FIG. 1 shows the test scores of students as a function of the tests taken in a single class. Another analysis of interest of the data in the three related sheets 121, 122, and 123 could be displaying the score of all tests of students as a function of classes. Unfortunately, however, providing this information typically involves building a specific table for this purpose by copying or referencing data from the tables of related sheets 121, 122, and 123.

FIG. 2 is an exemplary screenshot 200 of an Excel 2013 spreadsheet that includes a table 210 showing test scores of students displayed as a function of classes that was built by copying or referencing data from the tables of related sheets 121, 122, and 123 of FIG. 1. For example, the values of column E and rows 3 through 6 in table 210 of FIG. 2 are copied or references from the values of column F and rows 3 through 6 of table 110 of FIG. 1.

This method of providing different views of data that has N related data dimensions is time consuming and inflexible. It is time consuming in that each new view or table used to analyze the data is built by hand. It is inflexible in that each new view or table used to analyze the data is only useful for a specific view or analysis.

Another method of providing different views of data that has N related data dimensions is to gather the N related data dimensions into a table that can be read by a pivot table. A pivot table is a spreadsheet application function that can automatically recognize N related data dimensions in a table and output data of the table as a function of any of the N related data dimensions.

The problem with this method is that the N related data dimensions have to be organized into a single table that the pivot function can read. In addition, since spreadsheets are inherently made up of two dimensional tables of cells, expressing data for N related data dimensions as a two dimensional table of cells requires copying or referencing redundant information by hand.

FIG. 3 is an exemplary screenshot 300 of an Excel 2013 spreadsheet that includes a table 310 that gathers three related data dimensions into one table that can be read by a pivot table. The three related data dimensions are students, tests, and classes. The three related data dimensions are copied or reference by hand from the tables of related sheets 121, 122, and 123 of FIG. 1. Note that since spreadsheets are inherently made up of two dimensional tables of cells, expressing data for the third related data dimension, class, requires copying or referencing redundant information. For example, column B of table 310 lists each of Class1, Class2, and Class 3 four times. This means that these dimension values each have to be copied or referenced by hand (by selecting) four times. Currently, spreadsheets do not provide any systems and methods to automatically generate a two dimensional table of cells, such as table 310, that includes information for expressing N related data dimensions gathered from two or more other spreadsheet tables.

From table 310 a pivot table can be generated. From the pivot table any of the three related data dimensions can be combined with any of the other three related data dimensions in a report or view of the data. However, a pivot table does not allow “writeback” to the original table from which the pivot table was generated. In other words, if any of the data or formulas of a report or view generated by the pivot table is changed, the change information cannot be written back to the table of N related data dimensions from which the pivot table was generated.

One reason information cannot be written back to a table used by a pivot table is that there is no order of precedence of the calculations stored in these tables. In addition, tables from which pivot tables are generated include provide no hierarchy of the data dimensions. Hierarchies must also be symmetrical as well to be understood by a pivot table.

As a result, systems and methods are needed to automatically generate a two dimensional table of cells that includes information for expressing N related data dimensions gathered from two or more other spreadsheet tables, to automatically allow any of the N related data dimensions to be used in a report or view generated from the two dimensional table of cells and to allow change information specified in a report or view to be written back to the two dimensional table of cells.

### BRIEF DESCRIPTION OF THE DRAWINGS AND APPENDICES

Appendix 1 is an exemplary presentation describing a spreadsheet prototyping and development function or add-in for prototyping and developing analytical applications, in accordance with various embodiments.

FIG. 1 is an exemplary screenshot of an Excel 2013 spreadsheet that includes a table showing test scores a number of tests for a number of students.

FIG. 2 is an exemplary screenshot of an Excel 2013 spreadsheet that includes a table showing test scores of students displayed as a function of classes that was built by copying or referencing data from the tables of related sheets of FIG. 1.

FIG. 3 is an exemplary screenshot 300 of an Excel 2013 spreadsheet that includes a table that gathers three related data dimensions into one table that can be read by a pivot table.

FIG. 4 is a block diagram that illustrates a computer system, in accordance with various embodiments.

FIG. 5 is an exemplary screenshot of an Excel 2013 spreadsheet that includes a table generated from a formula of a model table function or add-in that converts sheet names to a table, in accordance with various embodiments.

FIG. 6 is an exemplary screenshot of a spreadsheet that includes prototyping and development function or add-in, in accordance with various embodiments.

FIG. 7 is an exemplary screenshot of a spreadsheet that includes a lookup table, in accordance with various embodiments.

FIG. 8 is an exemplary screenshot of a spreadsheet showing how the students data dimension is obtained by highlighting two columns of an existing table, in accordance with various embodiments.

FIG. 9 is an exemplary screenshot 900 of a spreadsheet showing a window of the spreadsheet prototyping and development function or add-in that displays the data dimensions obtained from the spreadsheet program, in accordance with various embodiments.

FIG. 10 is an exemplary screenshot of a spreadsheet showing a model table generated from the data dimensions of two or more tables of an existing spreadsheet, in accordance with various embodiments.

FIG. 11 is an exemplary screenshot of a spreadsheet showing a window of the spreadsheet prototyping and development function or add-in that displays rules for data dimensions of a model table, in accordance with various embodiments.

FIG. 12 is an exemplary screenshot of a spreadsheet showing a window of the spreadsheet prototyping and development function or add-in that generates random data for the model table, in accordance with various embodiments.

FIG. 13 is an exemplary screenshot of a spreadsheet showing a model table that includes data that was imported with formulas, in accordance with various embodiments.

FIG. 14 is an exemplary screenshot of a spreadsheet showing a view table that includes information pulled from the model table of FIG. 13, in accordance with various embodiments.

FIG. 15 is an exemplary screenshot of a spreadsheet showing a view table that includes a GPA computed for all students for total classes and all tests, in accordance with various embodiments.

FIG. 16 is an exemplary screenshot of a spreadsheet showing a view of a step in function of the spreadsheet prototyping and development function or add-in, in accordance with various embodiments.

FIG. 17 is an exemplary screenshot of a spreadsheet showing specification document produced by the spreadsheet prototyping and development function or add-in, in accordance with various embodiments.

FIG. 18 is an exemplary screenshot of a spreadsheet showing a window of the spreadsheet prototyping and development function or add-in for exporting the model table, in accordance with various embodiments.

FIG. 19 is a flowchart showing a method for automatically generating a model table that has more than two data dimensions in a spreadsheet program by selecting the more than two data dimensions from two or more tables of the spreadsheet program, in accordance with various embodiments.

FIG. 20 is a schematic diagram of a system that includes one or more distinct software modules that performs a method for automatically generating a model table that has more than two data dimensions in a spreadsheet program by selecting the more than two data dimensions from two or more tables of the spreadsheet program, in accordance with various embodiments.

Before one or more embodiments of the invention are described in detail, one skilled in the art will appreciate that the invention is not limited in its application to the details of construction, the arrangements of components, and the arrangement of steps set forth in the following detailed description. The invention is capable of other embodiments and of being practiced or being carried out in various ways. Also, it is to be understood that the phraseology and terminology used herein is for the purpose of description and should not be regarded as limiting.

### DETAILED DESCRIPTION

### Computer-Implemented System

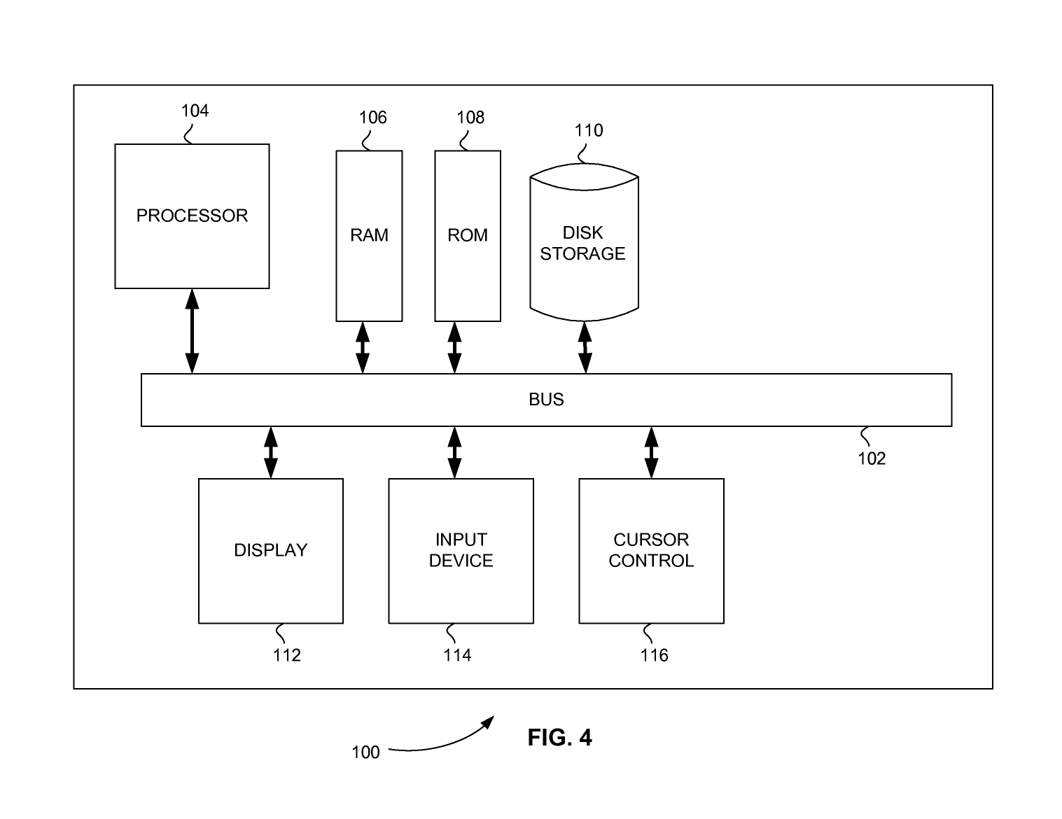

FIG. 4 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer, handheld device, smartphone, or tablet user. An input device 114, including alphanumeric and other keys, is coupled to bus 102 for communicating information and command selections to processor 104. Another type of user input device is cursor control 116, such as a mouse, touch screen, track pad, track point, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Generation of Table of N Data Dimensions

Systems and methods for automatically generating a model table that has more than two data dimensions in a spreadsheet program by selecting the more than two data dimensions from two or more tables of the spreadsheet program are described in this detailed description of the invention, which includes the accompanying Appendix 1. In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

Appendix 1 is an exemplary presentation describing a spreadsheet prototyping and development function or add-in for prototyping and developing analytical applications, in accordance with various embodiments.

As described above, it is typical that spreadsheets contain two or more tables with at least two data dimensions and that data of these two or more tables are related. In other words, it is typical that a spreadsheet contains data across two or more tables and this data is a function of more than two related data dimensions. As a result, it is desirable to view or report the data as different permutations of the more than two related data dimensions. To do this, however, requires the generation of a table or model of the more than two related data dimensions. Currently, spreadsheets do not provide any systems and methods to automatically generate a table or model of more than two data dimensions from two or more tables of the spreadsheet.

Further, once a table or model of more than two data dimensions is generated, the data of the two data dimensions can be viewed or reported as any permutation of the more than two data dimensions using a pivot table, for example. However, pivot tables provide limited functionality. For example, if any of the data or formulas of a report or view generated by the pivot table is changed, the change information is not written back to the table of the more than two related data dimensions from which the pivot table was generated.

As a result, systems and methods are needed to automatically generate a model table that includes information for expressing more than two related data dimensions gathered from two or more other spreadsheet tables, to automatically allow any of the more than two related data dimensions to be used in a report or view generated from the model table and to allow change information specified in a report or view to be written back to the model table.

In various embodiments, a function or add-in is added to a spreadsheet program to generate a model table that includes information for expressing more than two related data dimensions gathered from two or more other spreadsheet tables, to automatically allow any of the more than two related data dimensions to be used in a report or view generated from the model table, and to allow change information specified in a report or view to be written back to the model table. An add-in as defined herein is an additional application that can be added to a spreadsheet program without recompiling the spreadsheet program and has access to all the components of the spreadsheet program. A function as defined herein is a component of the spreadsheet program that is compiled in the spreadsheet program.

A model table function or add-in is added to a spreadsheet program by compiling the model table function with the spreadsheet or pointing the spreadsheet program to the model table function add-in. Once the model table function or add-in is added to the spreadsheet program it appears as a selection item in the spreadsheet program. A user executes the model table function or add-in by selecting its selection item. Once the model table function or add-in is executed, the user adds a data dimensions to a model table by selecting one or more rows or one or more columns of a table in the spread sheet program.

The model table function or add-in addresses a business challenge (viewing or reporting related data from different spreadsheet tables) that is particular to the spreadsheets. Various embodiments are rooted in computer technology in order to overcome a problem specifically arising in the realm of computer data analysis.

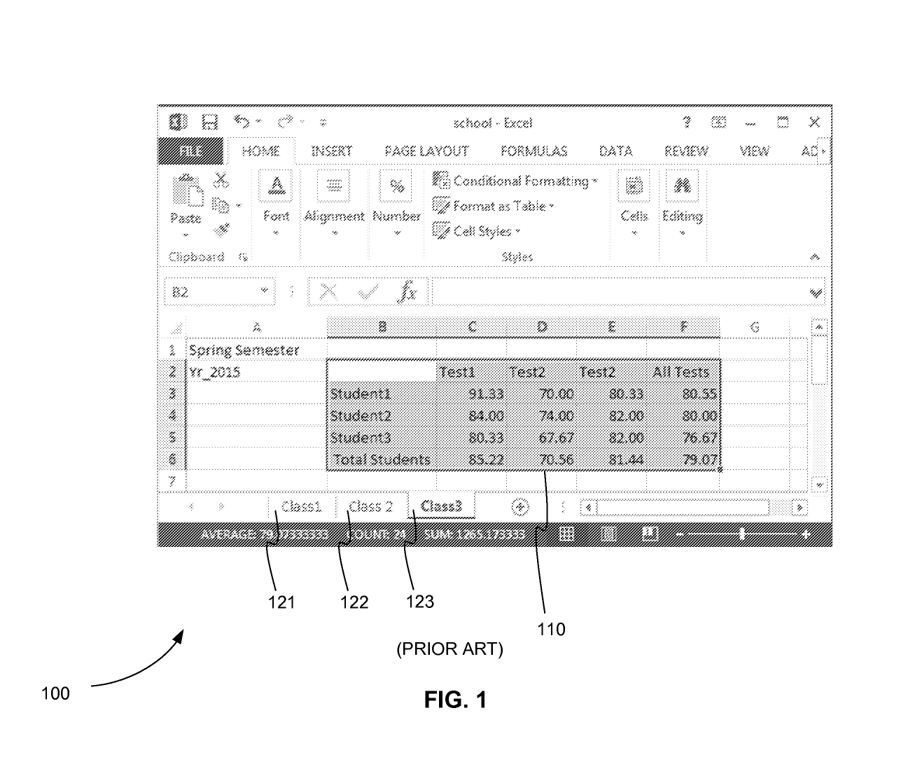

For example, returning to FIG. 1, a user generates the Students data dimension in the model table by selecting column B and rows 3 through 6 in table 1 of FIG. 1. The data dimension values received for a first data dimension of the model table are Student1, Student2, Student3, and Total Students. In various embodiments, the model table function or add-in can be directed to infer a hierarchy based on indentation or formulas. For example, the label Total Students is indented in cell B6. From this indentation the model table function or add-in can infer that Total Students is higher in the hierarchy of the data dimension students than Student1, Student2, and Student3. In other words, Total Students includes Student1, Student2, and Student3.

In various embodiments, a user can select the Students data dimension by selecting two columns. For example, columns B and C and rows 3 through 6 are selected. In this way the values Student1, Student2, Student3, and Total Students are selected along with their corresponding Test1 scores of 91.33, 84.00, 80.33, and 85.22. The scores are additionally selected to determine the data type of Student1, Student2, Student3, and Total Students. For example, the data types for 91.33, 84.00, and 80.33 of Student1, Student2, and Student3 are numerical values. However, the data type of 85.22 for Total Students is the average formula that takes the average of the preceding scores for Student1, Student2, and Student3. When the model table function or add-in is instructed that the selection will include data. The model table function or add-in obtains the data types from the data row or column selected and stores the data type with the data dimension. Therefore, for this example, value data types are stored with Student1, Student2, and Student3. However, for Total Students a formula that takes the average of the scores of Student1, Student2, and Student3 is stored for Total Students.

Similarly, a user generates the tests administered data dimension in the model table by selecting row 2 and columns C through F of table 110 in FIG. 1. The data dimension values received for this second data dimension of the model table are Test1, Test2, Test3, and All Tests. Again hierarchy can be determined from indention and/or data types can be saved with the tests administered data dimension by additionally selecting row 3 and columns C through F of table 110 in FIG. 1.

A third data dimension is the Classes dimension. Sheets 121, 122, and 123 include the data dimension values Class1, Class2, and Class3, respectively. In various embodiments, the model table function or add-in includes a formula for converting sheet names to a table.

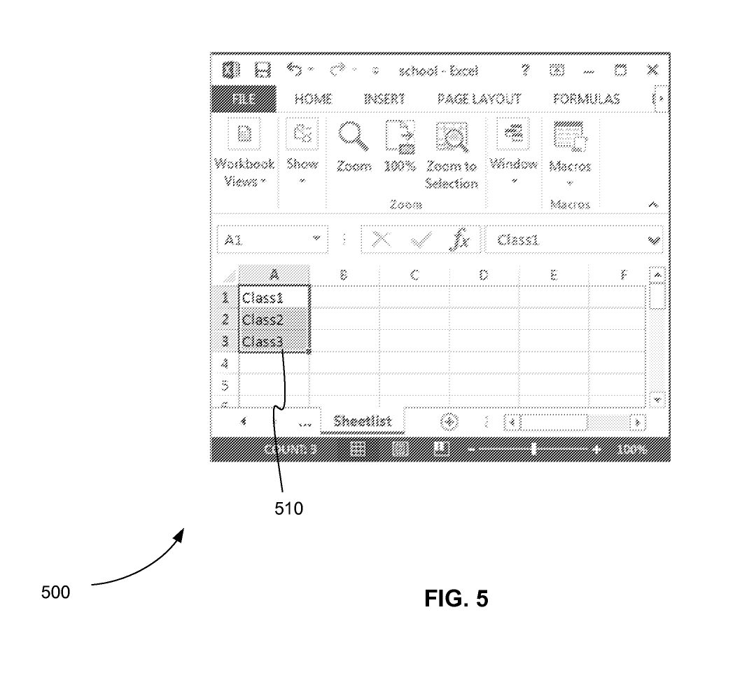

FIG. 5 is an exemplary screenshot 500 of an Excel 2013 spreadsheet that includes a table 510 generated from a formula of a model table function or add-in that converts sheet names to a table, in accordance with various embodiments. A user can then generate the Classes dimension in the model table by selecting column A and rows 1 through 3 of table 510. The data dimension values received for this third data dimension of the model table are Class1, Class2, and Class3.

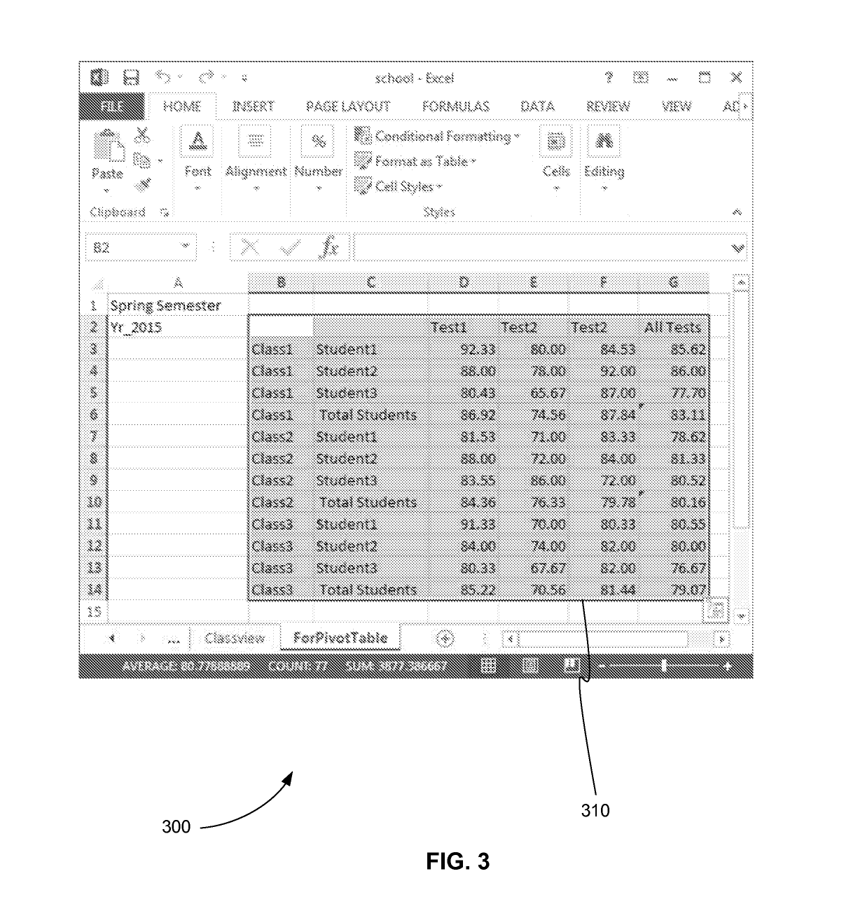

The model table is stored in the spreadsheet program as a table for example. As described above, three data dimensions, however, cannot be stored in a two-dimensional array of cells without using some redundancy. In various embodiments, therefore, the model table function or add-in automatically repeats the values or elements of at least one data dimension of the three different data dimensions, Students, Test administered, and Classes. For example, the model table function or add-in can repeat the Classes data dimension and produce a model table similar to table 310 of FIG. 3.

This automatic generation of information to represent data with more than two data dimensions as a two-dimensional array of cells of a spreadsheet reflects both an improvement in the functioning of the computer and an improvement in another technology (data analysis or data mining).

Note that table 310 of FIG. 3 includes data values in cells that include rows 3 through 14 and columns D through G. In various embodiments, a model table is built initially without any data. Data can be added later. For example, the model table function or add-in can include a selection item to generate random data for the model table. Selection of this selection item then causes the model table function or add-in to randomly generate the data values of the model table. Alternatively, the model table function or add-in can include a selection item to import the data values from table in the spreadsheet program or from other programs. Selection of this selection item then causes the model table function or add-in to import the data into the model table.

Note also that table 310 of FIG. 3 places the values of dimension data in separate cells. In various embodiments, the values of dimension data from two or more data dimensions can be stored in a same cell of the model table.

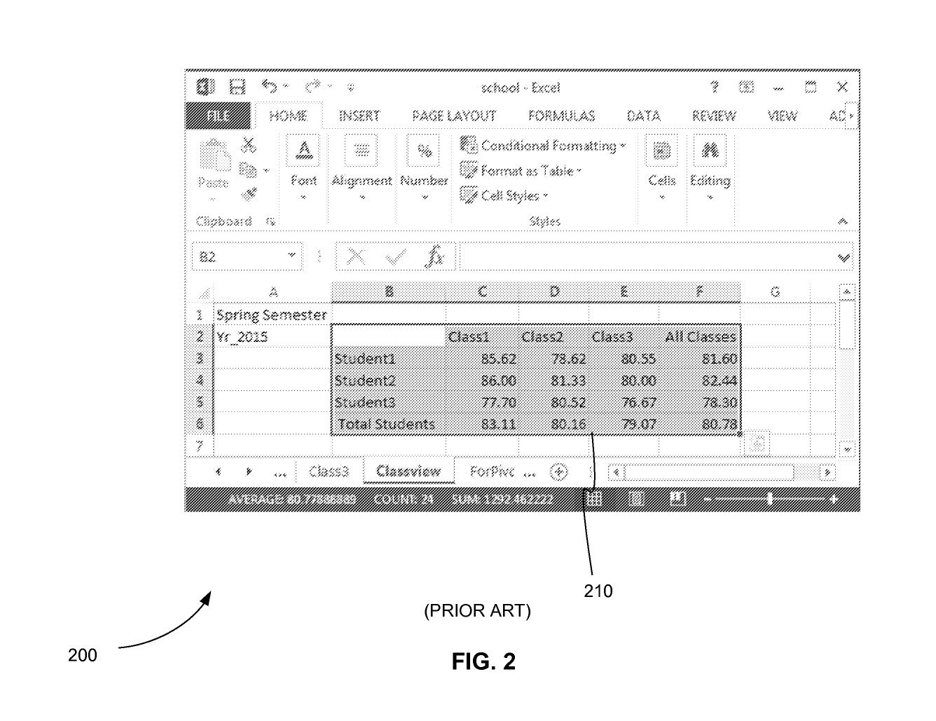

In various embodiments, the model table function or add-in further includes a selection item for viewing or reporting data from the model table as a function of two or more data dimensions. When this selection item is selected the user can select the data dimensions to display. For example, the user can select to view scores of students as function of classes as shown in table 210 of FIG. 2. The model table function or add-in then generates a view table in the spreadsheet program, like table 210 of FIG. 2, to view this information.

In various embodiments, the model table function or add-in further allows information in the view table, such as data and data types to be changed by the user. Any data type available to the spreadsheet program can be used. For example, data types can include, but are not limited to, numeric, text, date, url link, and selection items. These changes by the user are then written back to the model table by the model table function or add-in.

In various embodiments, the model table function or add-in further includes a selection item for entering rules regarding the data dimensions of the model table. When this selection item is selected the user can enter a rule as a syntax specific to the model table function or add-in. A rule, for example, can include the order in which data dimension values that have formula data types are allowed to execute the formula to produce data.

In various embodiments, the model table function or add-in is part of spreadsheet prototyping and development function or add-in used for rapid web application and application development for prototyping and developing analytical applications, which include, but are not limited to, business intelligence, performance management, and other business analytics. This spreadsheet prototyping and development function or add-in provides a complete process for gathering user reporting and analysis requirements, producing a working prototype for user sign off, and producing specifications for application development.

### Project Information

The project information portion of the spreadsheet prototyping and development function is designed to collect key information that relates to the prototype. This facilitates the development process by capturing all types of information required to develop the application in one place. A project and model table are created and key information such as project overview, scope, milestones, version, users, terminology and risks are gathered.

### Library

The library portion of the spreadsheet prototyping and development function allows users to import spreadsheets and other key information for developing the prototype and support the business requirements effort. The information imported to the spreadsheet is utilized to create the table model structure, data, and calculations of the prototype.

### Model Table Function or Add-in

As described above, the model table data dimensions are created from existing spreadsheet information. Users can utilize existing spreadsheet lists, formulas, tab names, and other data to produce the dimensions of the model structure. The dimension building is designed to leverage the existing spreadsheet information for ease of use. However, in various embodiments, the data dimensions can be produced by other means. The dimension build feature provides several techniques (indenting, formula, as is, level build, etc.) to collect dimension information from the spreadsheet.

### Model Table Structure

The model table structure is a flexible multi-dimensional storage design that dynamically expands row and columns for housing data in the cells of a spreadsheet database. The rows and columns of the array-based structure can be reconfigured for optimizing data storage. It maintains inter-relating calculation logic that fully leverages the functionality of the spreadsheet program. The model structure acts as a data store to support any type of query from the different dimensions. It also allows for write-back to the spreadsheet database making it unique when compared to other pivot table technologies.

### Rule Engine

The rule engine portion of the spreadsheet prototyping and development function or add-in is designed to leverage the underlying functionality of the spreadsheet program. The application utilizes standard spreadsheet logic to produce formulas that relate to dimension members. This produces an equation that equates to a formula associated with the model. For instance, the application takes an equation in spreadsheet logic like the following: B4=B1+B2+B3, and transforms it into model logic such as {Total Students}={Student1}+{Student2}+{Student3}.

The rule engine employs the inherent functions associated with the spreadsheet program. For instance, the rule engine dynamically drives the algorithms in the functional library. Therefore, all functions (i.e., Financial, Logical, Text, Date & Time, Lookup & Reference, Math, etc.) intrinsic to the spreadsheet program are available for use. Common examples of these functions are AVERAGE, SUM, IRR, PMT, VLOOKUP, etc. Leveraging the model design, the rule engine can also produce time intelligence and other key capabilities to solve intricate problems. For instance, it can time intelligence such as calculating prior period or utilize spreadsheet extensions (i.e., Solver, etc.) to model for complex problems. It also provides custom functions unique to the model design (e.g., link models to each other).

Via a one-of-a-kind array-based algorithm, the application inserts the calculation logic across the dynamically defined data storage layout. It employs a unique reverse calculation ordering scheme that optimizes the efficiency in writing calculations to the spreadsheet that preserves calculation precedence.

### Data Importing/Exporting

The spreadsheet prototyping and development function or add-in allows for importing/exporting of data. This data can be imported from spreadsheets that house data from existing back end systems. The data aspect of the spreadsheet prototyping and development function or add-in allows for random data generation to help diagnose and validate model calculations. A random data generator deploys unique methods of randomness that closely parallel the data provided by the user, therefore, better simulating the real world problem and making it easier to visualize the solution.

### Model Table Development

Each aspect of developing the spreadsheet prototyping and development function or add-in runs independently giving users flexibility during prototype development. This enhances the user experience in designing and diagnosing the solution as the prototype is developed.

### Views

Any time after the model table structure is developed; the user can produce views the data of model table. The user can slice and dice the structure to produce reports and planning input forms that support the application requirements. The result is a prototype that users can sign off on before a more large scale effort occurs, thus increasing user buy in and greatly reducing potential application rework.

### Diagnostic Tools

Inherent in the spreadsheet prototyping and development function or add-in is a unique set of diagnostic tools that help users analyze the results of their models. A find history tool, for example, helps users understand the calculation logic and how it occurs. For instance, during the development of the model table, multiple calculations from the different dimensions may directly impact what is housed in a cell. The last calculation that occurs is the one that resides in the cell. Utilizing the calculation order, the diagnostic tool provides the user with an understanding of the sequence of calculations. Consequently, if desired, the user can re-order the calculations if they want a different calculation to reside in the cell.

The step-in diagnostic tool, for example, is a one-of-a-kind multi-dimensional calculation precedence routine. It allows the user to step into the calculation to trace the data results as it flows through the model logic. This dramatically helps in ascertaining where there is an issue in the model design.

### Model Exporting

The spreadsheet prototyping and development function or add-in houses data, structure, and calculation logic is utilized to produce a traditional business analysis model. The components of spreadsheet prototyping and development function or add-in are transformed to create a contemporary performance management or business intelligence application to support further use and/or development.

### Specifications

The spreadsheet prototyping and development function or add-in allows a user to produce a document that provides the requirements of the application. This document is a by-product of the project information and model development that occurs when producing the prototype. This document becomes integral in assisting in the development of the application with contemporary performance management and business intelligence tools.

### Model Development Example

### Scenario

A University wants to compute the average grades and GPAs of its students for the spring semester and compare to the prior fall semester.

### Library

The University has a spreadsheet created to help them perform this analysis. However, it lacks the different ways they want to analyze the information and difficult to maintain.

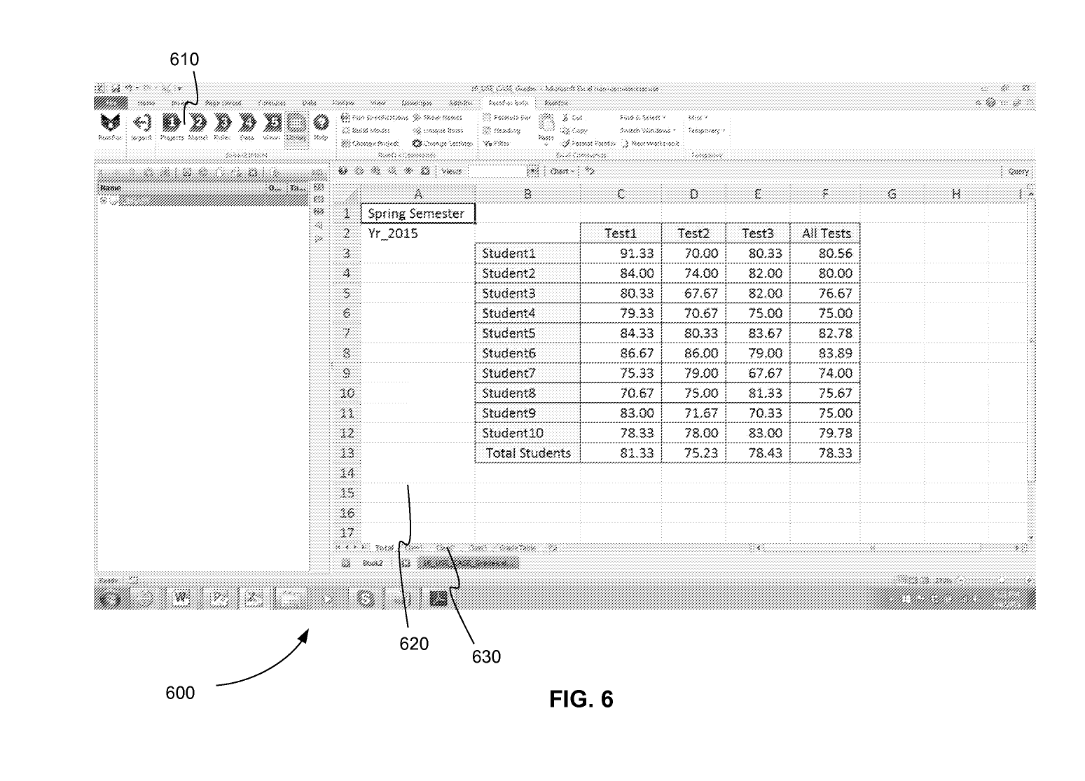

FIG. 6 is an exemplary screenshot 600 of a spreadsheet that includes prototyping and development function or add-in, in accordance with various embodiments. Selection items of the prototyping and development function or add-in are shown in menu area 610.

Sheet 620 shows the many data dimensions and members in those dimensions that potentially comprise a model table. For example, sheet 620 includes a students data dimension (first data dimension—11 members) and a tests data dimension (second data dimension—4 members). The tabs 630 of sheets represent a classes data dimension (third data dimension—4 members). In the upper left column in cell A1 includes “Spring Semester”. There is another workbook, workbook that has the “Fall Semester,” for example. Therefore, there is also a Semesters data dimension (fourth data dimension—4 members counting variance and percentage variance calculations). The test score and eventual computation of grade and GPA make up a metrics data dimension (fifth data dimension—3 members).

In this workbook, there are several calculations taking place. There are 14 calculations on every class worksheet totaling 42 ((4+10)×3) calculations. Every cell on the Total Class sheet 620 is calculated equaling 44 (4×11), therefore the total calculations in this workbook are 86 (42+44). Note the calculations for the Total Class worksheet students and tests are different than the other Class worksheets. Also, in addition to the score, the grade and GPA can be computed. This is computed from a lookup table, for example.

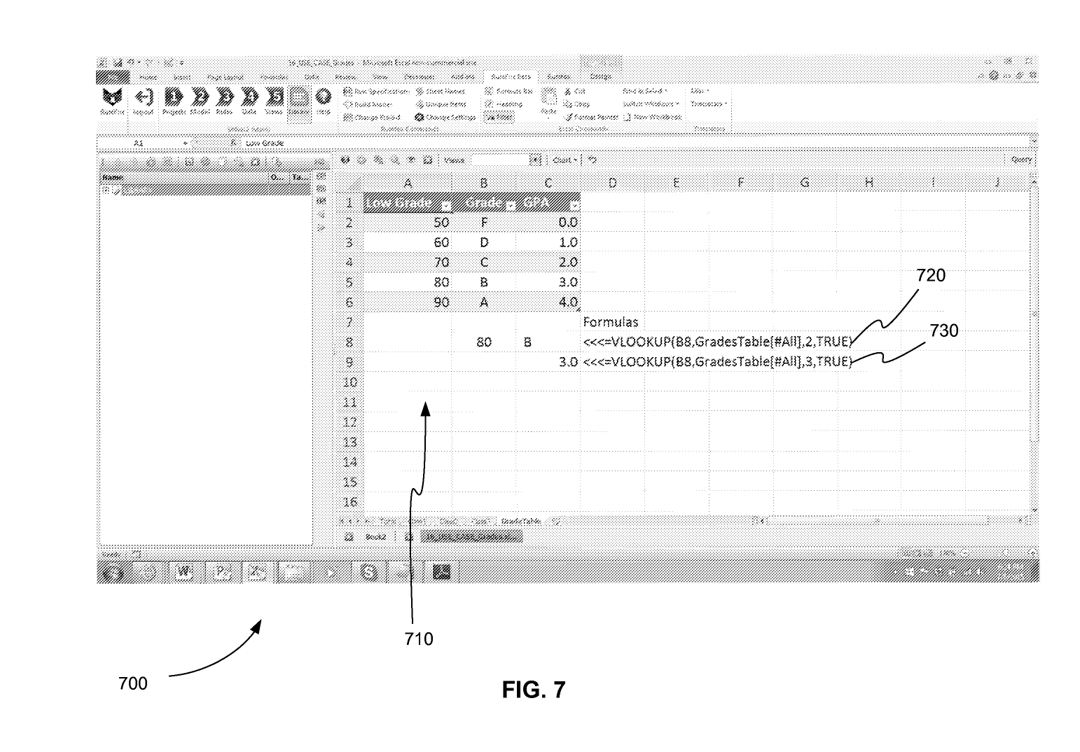

FIG. 7 is an exemplary screenshot 700 of a spreadsheet that includes a lookup table 710, in accordance with various embodiments. Lookup table converts test scores to grades and GPAs. For example, if the score in cell B8 is 80, then the grade is a B (cell C8) and the GPA is 3.0 (cell C9). Formula 720 is the formula of cell c8 that calculates the letter grade and formula 730 is the formula of cell C9 that calculates grade point average (GPA). These calculations have to be applied to every test for every student for every class. Since there are 44 calculations per worksheet (2×44×4), which sums up to 352 additional calculations equaling 438 calculations needed per semester workbook. So combined, spring and fall semester workbooks have 876 calculations. Finally, a variance and percentage variance is computed between the fall and spring semesters. There are (4×11×4) scores, or 528 scores, per workbook times 2 (variance and % variance) calculations equals a total of 1932 calculations. Thus, there are almost 2000 calculations to manually create, maintain, and ensure the right logic is being performed in each cell. (Note 180 cells are data so the total cells in the solution are 2112).

### Dimension Build

The spreadsheet prototyping and development function or add-in leverages an existing spreadsheet tables to develop the model table. By highlighting portions of a table in the existing spreadsheet the model table is generated. This can be done for each of the different data dimensions.

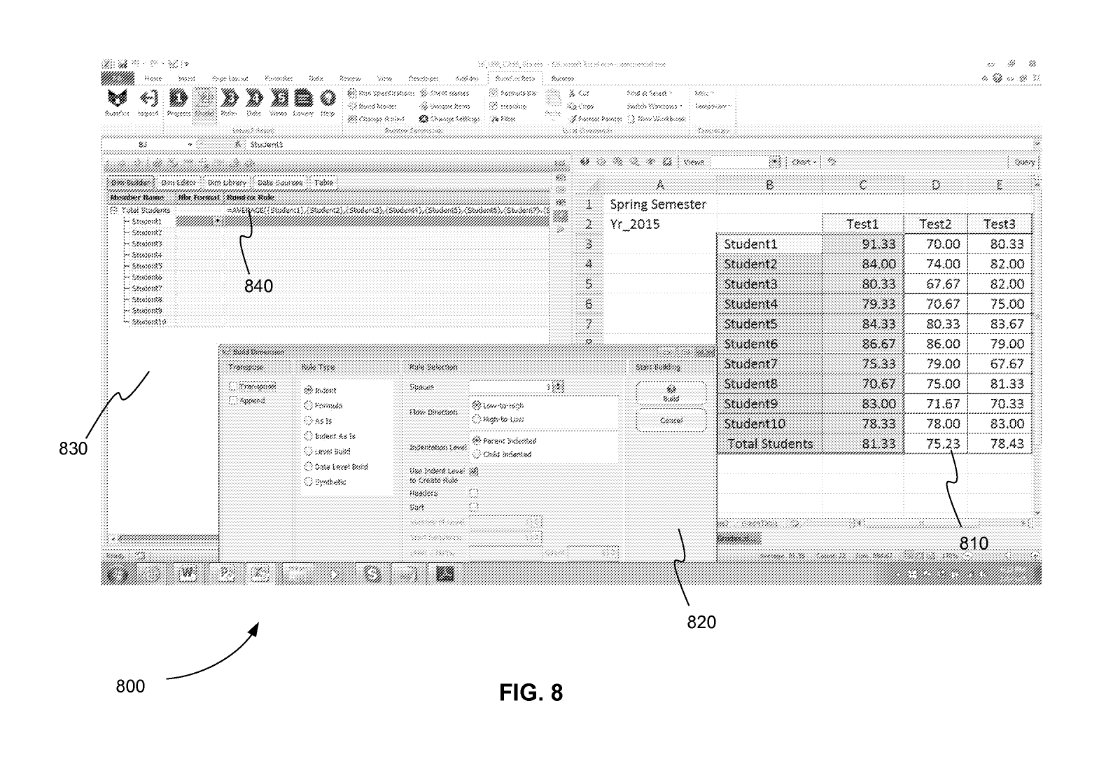

FIG. 8 is an exemplary screenshot 800 of a spreadsheet showing how the Students data dimension is obtained by highlighting two columns of an existing table 810, in accordance with various embodiments. Columns B and C of table 810 are highlighted. Build Dimension popup 820 allows the selection of formulas from column C of table 810. Dimension builder window 830 shows that Students data dimension values were successfully selected from table 810. Dimension builder window 830 shows the hierarchy of the Students data dimension values. For example, Total Students include Student1, Student2, . . . , etc. Dimension builder window 830 also shows that students data dimension includes rule 840, which is that the score of the Total Students data dimension is an average of the scores of all of the student scores. All data dimensions of the model table are highlighted and selected from tables of the spreadsheet program.

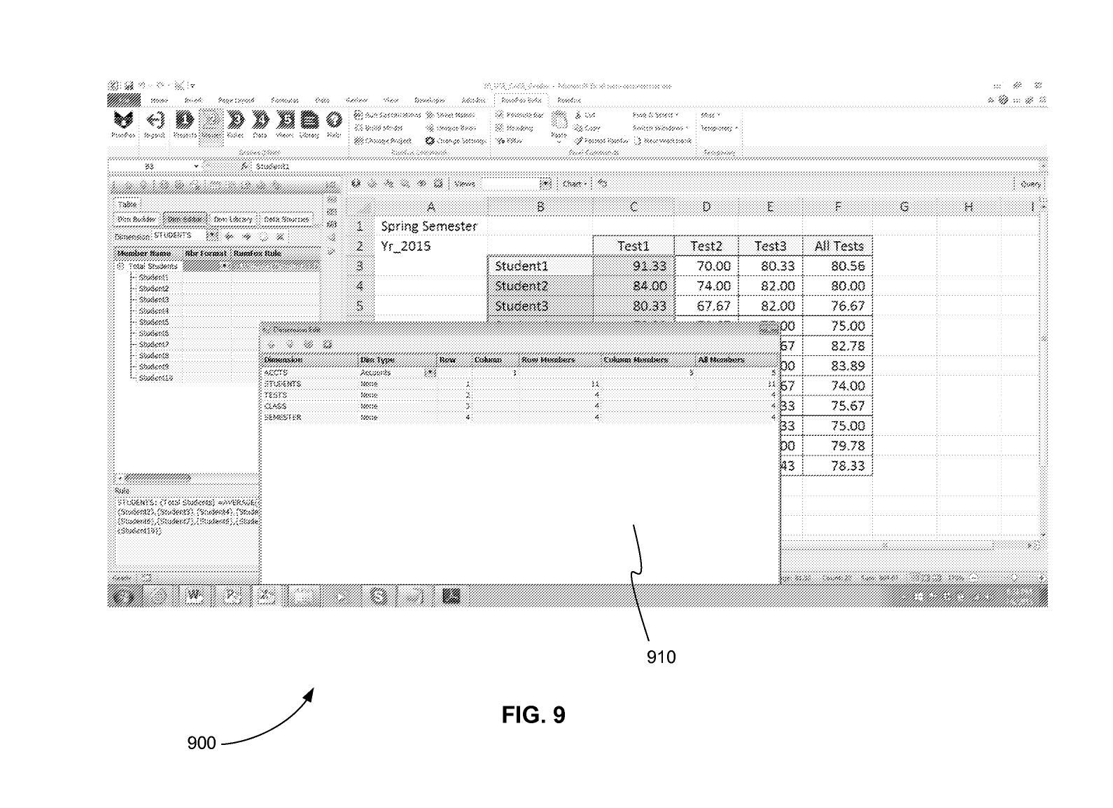

FIG. 9 is an exemplary screenshot 900 of a spreadsheet showing a window 910 of the spreadsheet prototyping and development function or add-in that displays the data dimensions obtained from the spreadsheet program, in accordance with various embodiments. Window 910 of the spreadsheet prototyping and development function or add-in lists data dimensions ACCTS, STUDENTS, TESTS, CLASS, and SEMESTER. The data dimensions include a total of 2,112 data dimension values or members. In various embodiments, row and column numbering determines how the model table is created. A user can dynamically set this numbering to support different model size and calculation needs. In the background on in a separate workbook hidden from the user, for example, the model table structure is developed.

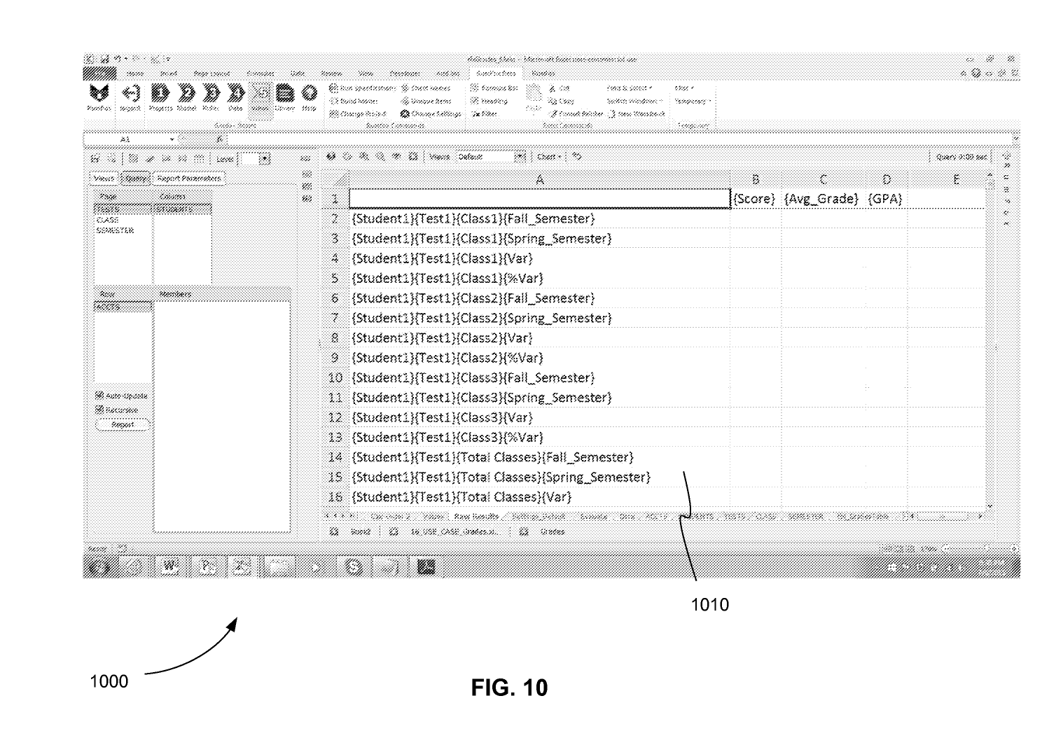

FIG. 10 is an exemplary screenshot 1000 of a spreadsheet showing a model table 1010 generated from the data dimensions of two or more tables of an existing spreadsheet, in accordance with various embodiments. Model table 1010 includes the Students, Tests, Classes, Semesters and Accts data dimensions. Note that the four data dimensions of model table 1010 are stored in a single column.

### Rules

Once the model table structure is created, rules can be developed. By leveraging the spreadsheet program to develop the model table structure, the rules from the spreadsheet are also utilized to produce the model table.

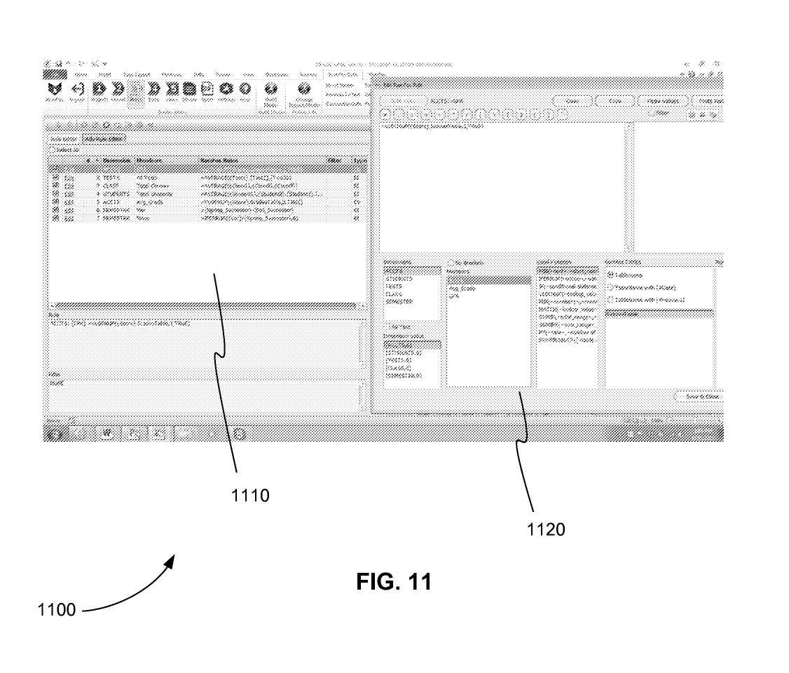

FIG. 11 is an exemplary screenshot 1100 of a spreadsheet showing a window 1110 of the spreadsheet prototyping and development function or add-in that displays rules for data dimensions of a model table, in accordance with various embodiments. Window 1110 lists seven rules. Five of the seven rules are created during the generation of the model table. The other two rules are copied from the table lookup worksheet. Window 1110 shows the rules in their rule order to the left with the individual rule and filter of the highlighted rule shown below. The rule order constitutes the sequence in which the rules are applied to the model structure (i.e., rule 1 is applied, then rule 2, etc.). A unique method is applied, where the rule order is reversed when the rules are applied, therefore minimizing the writing to the database.

There are several aspects to rule editor window 1120. For instance, the rule in rule editor window 1120 shows how a user passes parameters to the spreadsheet functions (i.e., {Score}) to dynamically drive the formulas in the model structure. A filter allows the user to refine the calculations applied to certain areas of the model table structure. The dimension value passes the relative value for each dimension member through to the rule. The “0” allows the user to pass the value for the relative position of the member in its corresponding dimension. This is valuable in establishing time intelligence (e.g., prior period, YTD) and other types of model requirements.

In this example, this one rule is creating the GPA metric by passing the {Score} metric to the spreadsheet LOOKUP function for every student, for every test, for every class, for every semester. The calculation order dictates the sequence in which the rules are applied to the model table. Since the calculation order is read in reverse, the writing of the GPA metric is optimized by only applying the rule to the cell required.

The spreadsheet prototyping and development function or add-in is a spreadsheet agnostic solution that establishes a multi-dimensional model table inherent in the spreadsheet technology and then utilizes the intrinsic spreadsheet functionality, and applies the calculation logic with appropriate relative positioning to the model table to insure calculations occur properly. This routine is performed without any manual entry required to the spreadsheet model table if that spreadsheet resides on disk, online or in memory.

### Data

The spreadsheet prototyping and development function or add-in provides methods in which to import data from back end systems or develop random data that specifically applies to the business requirements. This helps in the users understanding of the prototype and also helps in the diagnostics of the model's logic.

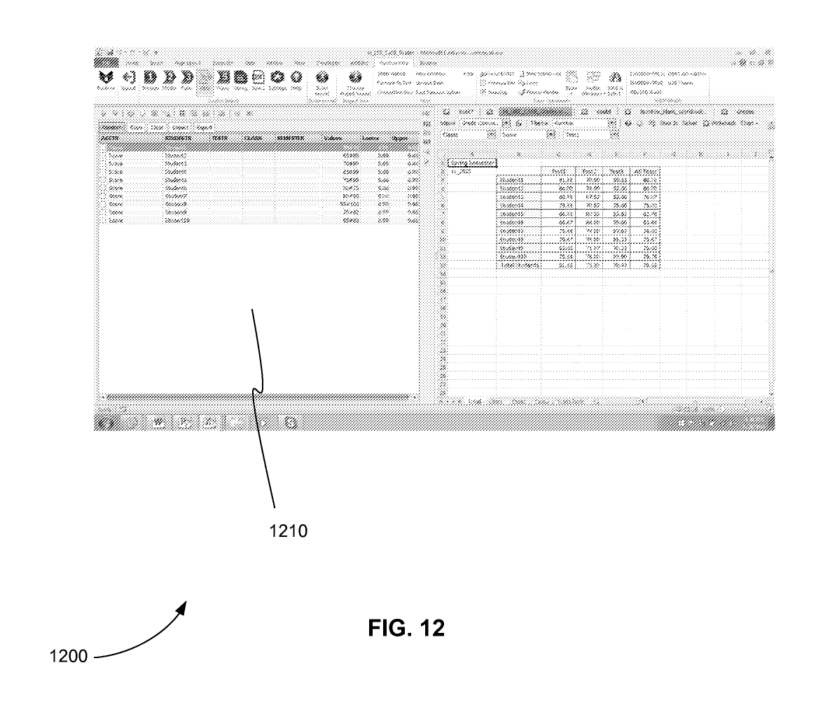

FIG. 12 is an exemplary screenshot 1200 of a spreadsheet showing a window 1210 of the spreadsheet prototyping and development function or add-in that generates random data for the model table, in accordance with various embodiments. In this example, the rule is setting random scores in different ranges for each student, test, class, and semester to mimic a real world scenario.

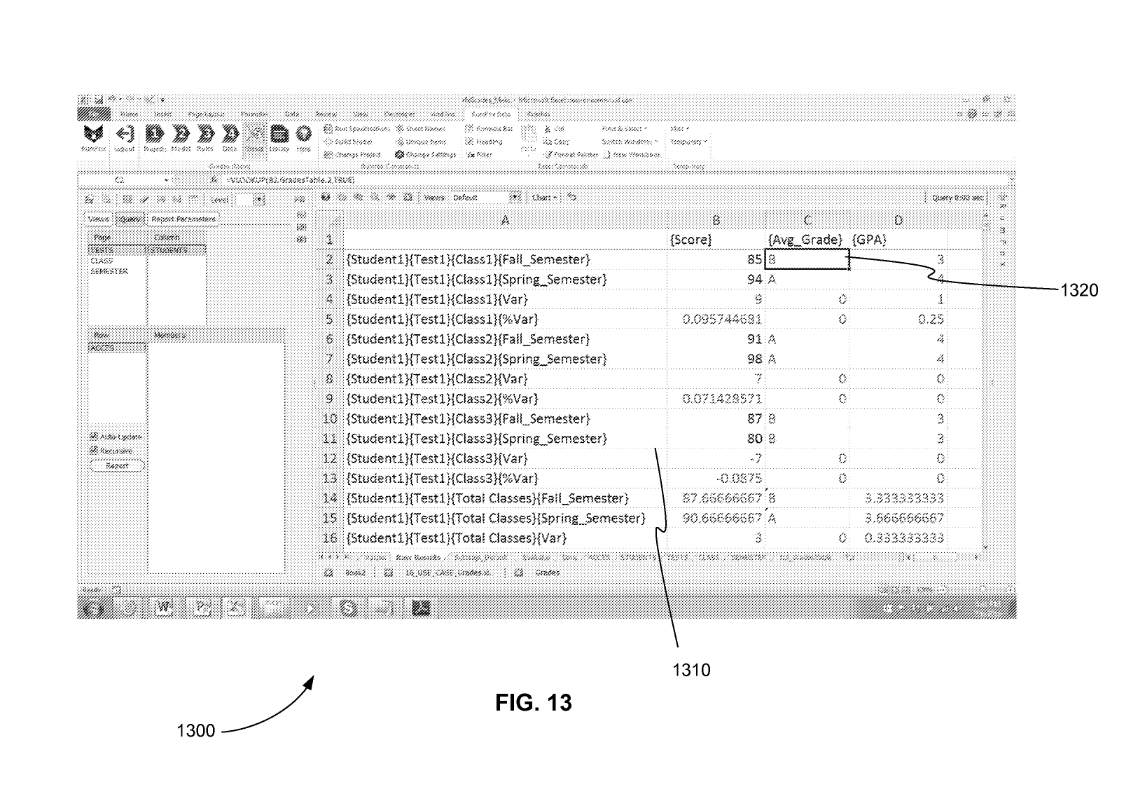

FIG. 13 is an exemplary screenshot 1300 of a spreadsheet showing a model table 1310 that includes data that is imported with formulas, in accordance with various embodiments. Each formula and the associated logic are applied. The formula of selected cell 1320, which is a lookup formula, shows how the lookup formula references the appropriate cells without any manual entry. In this example, 1932 calculations in the original model table are performed using seven rules. A user can dynamically pull from model table 1310 any view to support their analysis.

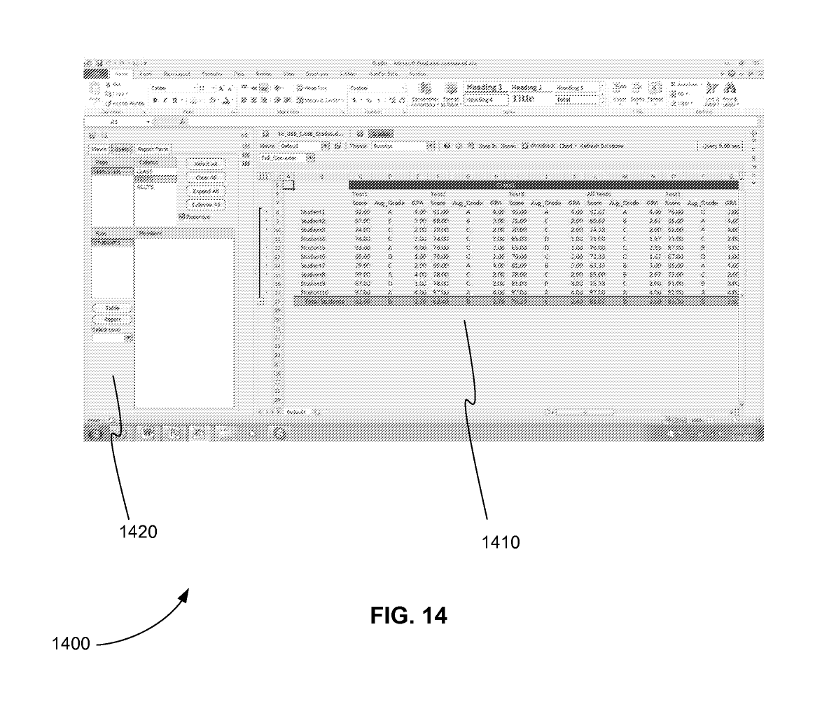

FIG. 14 is an exemplary screenshot 1400 of a spreadsheet showing a view table 1410 that includes information pulled from the model table of FIG. 13, in accordance with various embodiments. View table 1410 displays the score and average grade for all tests for all classes. Panel 1420 allows users to set up the view to the desired layout. The spreadsheet prototyping and development function or add-in leverages the spreadsheet formatting capabilities as well.

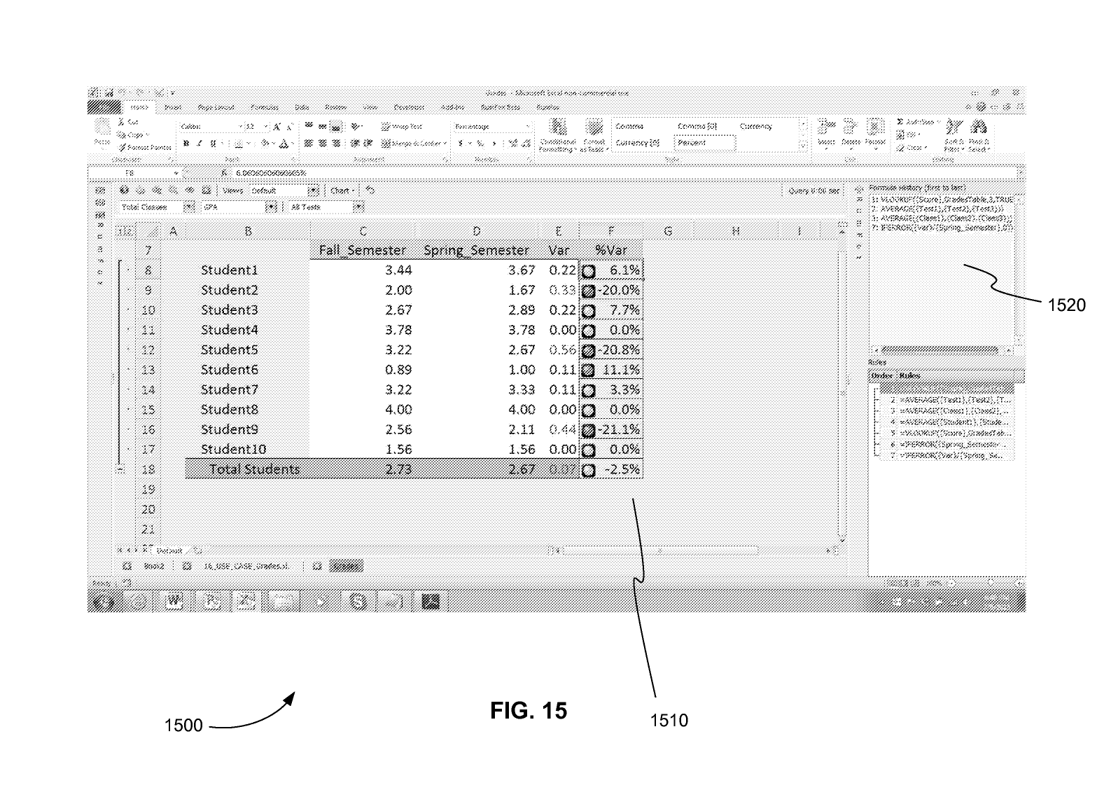

FIG. 15 is an exemplary screenshot 1500 of a spreadsheet showing a view table 1510 that includes a (WA computed for all students for total classes and all tests, in accordance with various embodiments. In this example, the user has selected a find history function on the % variance cell for Student1. Panel 1520 shows the sequence of calculations that occurred on that cell when the model table was created. This provides a method to diagnose the order of the calculation logic to ensure the proper calculation occurs on this cell.

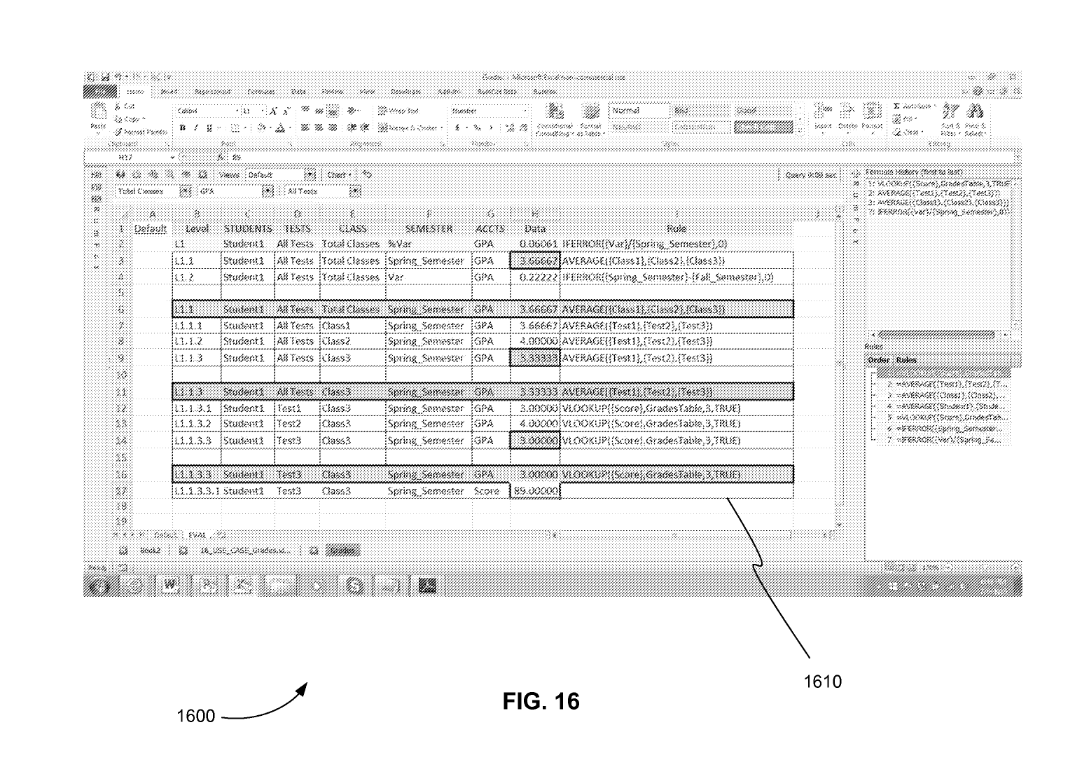

FIG. 16 is an exemplary screenshot 1600 of a spreadsheet showing a view 1610 of a step in function of the spreadsheet prototyping and development function or add-in, in accordance with various embodiments. View 1610 walks through the logic of the model table by the data elements. The user can step in from any cell to trace the precedence of the data for that rule. This is a multi-dimensional tracing routine that traces back to the actual score for one of the tests, for example.

### Specifications

Once the model is created and project information is provided, the user can produce a specification document outlining the details associated with the prototype. This can be provided to the developers.

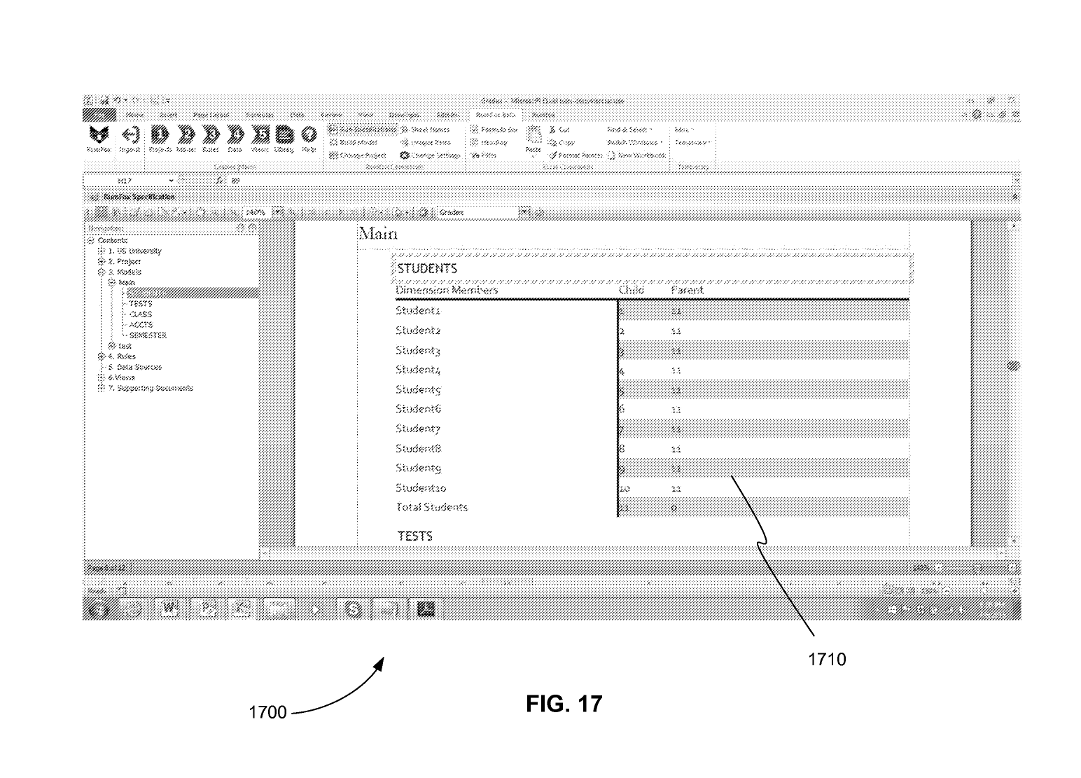

FIG. 17 is an exemplary screenshot 1700 of a spreadsheet showing specification document 1710 produced by the spreadsheet prototyping and development function or add-in, in accordance with various embodiments.

### Model Export

The model table can then be exported to other contemporary multi-dimensional application program in the marketplace for development.

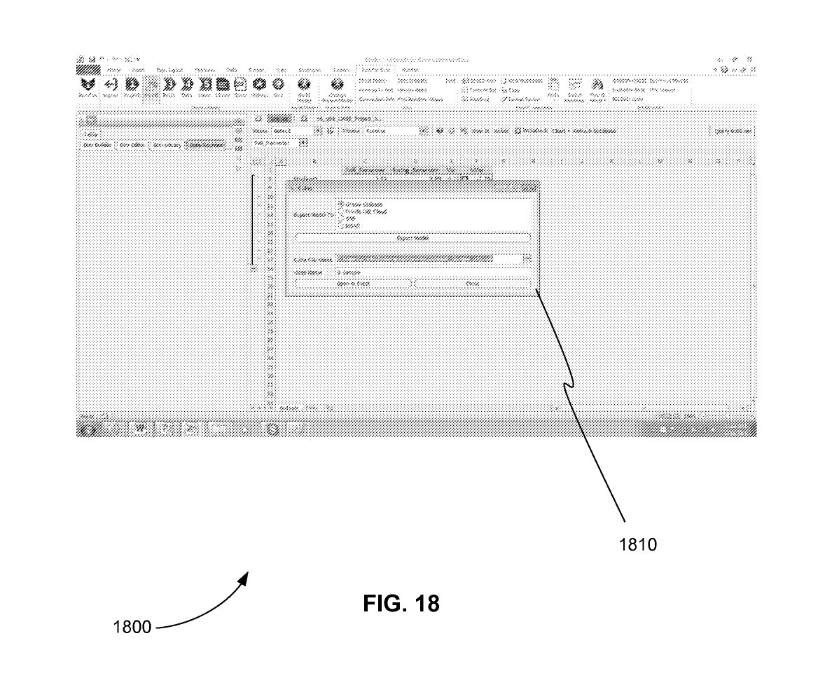

FIG. 18 is an exemplary screenshot 1800 of a spreadsheet showing a window 1810 of the spreadsheet prototyping and development function or add-in for exporting the model table, in accordance with various embodiments.

### System for Generating a Model Table

FIG. 4, for example, shows a system for automatically generating a model table that has more than two data dimensions in a spreadsheet program by selecting the more than two data dimensions from two or more tables of the spreadsheet program. The system of a FIG. 4 includes a display device 112, a pointing and selection device 116, and processor 104.

Display device 112 displays one or more row and column cells of one or more spreadsheets of a spreadsheet program. One or more spreadsheets can be one or more worksheets or sheets or one or more workbooks, for example.

Pointing and selection device 116 allows the selection of one or more row cells or one or more column cells of the one or more spreadsheets.

Processor 104 is in communication with display device 112 and pointing and selection device 116. Processor 104 executes the spreadsheet program. Processor 104 executes a model table function or add-in as part of the spreadsheet program after receiving from pointing and selection device 116 an indication that a selection item of the spreadsheet program displayed on display device 112 for the model table function or add-in is selected. In other words, processor 104 runs the model table function or add-in when it is selected by the user as a selection item of the spreadsheet program.

Processor 104 receives from pointing and selection device 116, using the model table function or add-in, more than two selections of one or more rows or columns from two or more tables of the spreadsheet program displayed on the display device 112. Each selection of the more than two selections represents a different data dimension of more than two different data dimensions selected from the two or more tables. In other words, the model table function or add-in receives and interprets selections of rows and columns from two or more tables as selections of data dimensions.

Processor 104 generates, using the model table function or add-in, a model table with more than two data dimensions in the spreadsheet program from the more than two different data dimensions selected from the two or more tables by automatically repeating the elements of at least one data dimension of the more than two different data dimensions. In other words, the model table function or add-in generates the data dimensions of a model table in the spreadsheet from the selected rows and columns. Since a table is a two-dimensional array of cells, the model table function or add-in automatically repeats elements of at least one data dimension so that a model table with more than two data dimensions can be represented by a two-dimensional array of cells.

In various embodiments, the model table function or add-in allows data to be imported into the generated model table from a variety of sources. For example, processor 104 further displays on the display device 112, using the model table function or add-in, a selection item for importing data for the model table. Processor 104 imports data for the model table, using the model table function or add-in, when it receives from pointing and selection device 116, using the model table function or add-in, an indication the selection item for importing data for the model table is selected. The indication can include the source of the data to be imported. The source can be, but is not limited to, a spreadsheet table or a file.

In various embodiments, the model table function or add-in allows random data to be generated for the model table. For example, processor 104 further displays on display device 112, using the model table function or add-in, a selection item for generating random data for the model table. Processor 104 generates random data for the model table, using the model table function or add-in, when it receives from pointing and selection device 116, using the model table function or add-in, an indication the selection item for generating random data for the model table is selected. The indication can include parameters for generating the random data.

In various embodiments, the model table function or add-in can display information from the model table as function of any data dimension in a view or report. For example, processor 104 further displays on display device 112, using the model table function or add-in, a selection item for viewing or reporting data from the model table on the display device as a function of two or more data dimensions of the more than two different data dimension. When processor 104 receives from pointing and selection device 116, using the model table function or add-in, an indication the selection item for viewing or reporting data from the model table is selected, it generates in the spreadsheet program, using the model table function or add-in, a view table with data from the model table expressed as a function of the two or more data dimensions and displays the view table on the display device.

In various embodiments, the model table function or add-in allows changes made in the view table to be written back to the model table. For example, processor 104 further receives from pointing and selection device 116, using the model table function or add-in, a change to one or more cells of the view table, and writes back, using the model table function or add-in, the change to the model table.

In various embodiments, the model table function or add-in determines the hierarchy of data dimension values or members from indentions in the data dimension values or members. For example, when a selection of the more than two selections of one or more rows or columns from two or more tables of the spreadsheet program received from pointing and selection device 116 includes one row or one column and a value of the one row or column is indented with respect to other values of the one row or one column, processor 104 further, using the model table function or add-in, creates a hierarchy of the values in the one row or one column and places the value that is indented higher in the hierarchy than the other values.

In various embodiments, the model table function or add-in determines data types of data dimension values or members from additional rows or columns of data that are highlighted along with the data dimension values. For example, when a selection of the more than two selections of one or more rows or columns from two or more tables of the spreadsheet program received from pointing and selection device 116 includes two rows or two columns, processor 104 further, using the model table function or add-in, examines the second row or second column for data types of the data related to each data dimension values and stores the datatype with each data dimension value.

In various embodiments, the model table function or add-in also allows rules to be entered and stored with the model table. For example, processor 104 further displays on display device 112, using the model table function or add-in, a selection item for entering rules for the model table. When processor 104 receives from pointing and selection device 116, using the model table function or add-in, an indication the selection item for entering rules is selected, it receives from the pointing and selection device, using the model table function or add-in, one or more rules entered and stores, using the model table function or add-in, the one or more rules entered with the model table.

### Method for Generating a Model Table

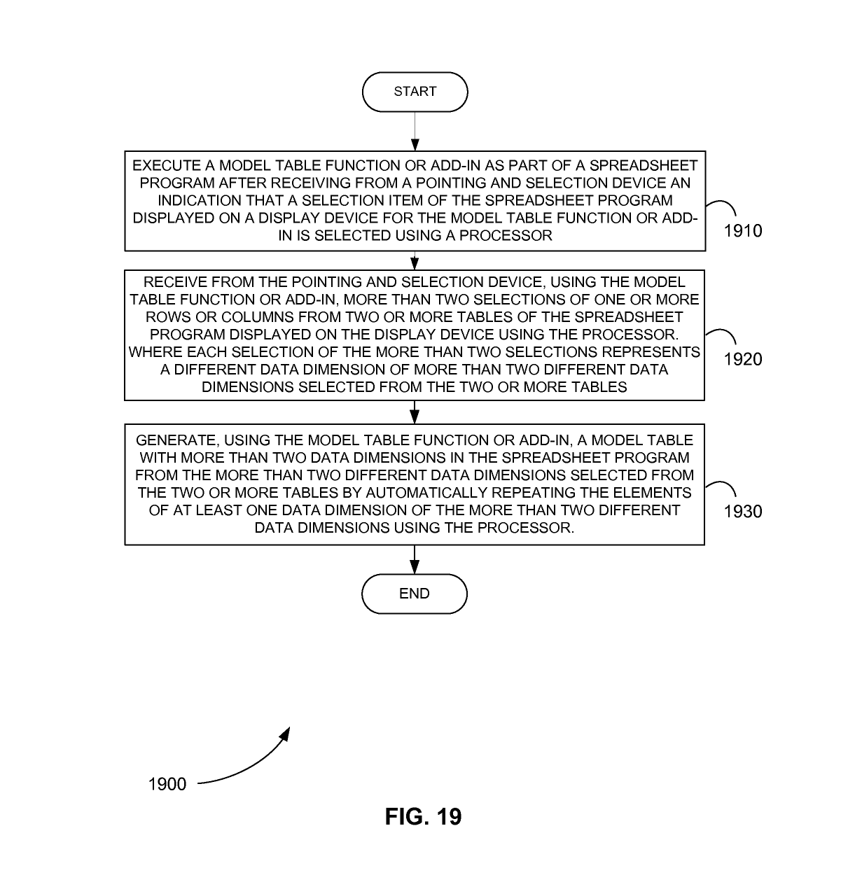

FIG. 19 is a flowchart showing a method 1900 for automatically generating a model table that has more than two data dimensions in a spreadsheet program by selecting the more than two data dimensions from two or more tables of the spreadsheet program, in accordance with various embodiments.

In step 1910 of method 1900, a model table function or add-in is executed as part of a spreadsheet program after receiving from a pointing and selection device an indication that a selection item of the spreadsheet program displayed on a display device for the model table function or add-in is selected using a processor.

In step 1920, more than two selections of one or more rows or columns from two or more tables of the spreadsheet program displayed on the display device are received, using the model table function or add-in, from the pointing and selection device using the processor. Each selection of the more than two selections represents a different data dimension of more than two different data dimensions selected from the two or more tables.

In step 1930, a model table with more than two data dimensions is generated in the spreadsheet program, using the model table function or add-in, from the more than two different data dimensions selected from the two or more tables by automatically repeating the elements of at least one data dimension of the more than two different data dimensions using the processor.

### Computer Program Product for Generating a Model Table

In various embodiments, computer program products include a tangible computer-readable storage medium whose contents include a program with instructions being executed on a processor so as to perform a method for automatically generating a model table that has more than two data dimensions in a spreadsheet program by selecting the more than two data dimensions from two or more tables of the spreadsheet program. This method is performed by a system that includes one or more distinct software modules.

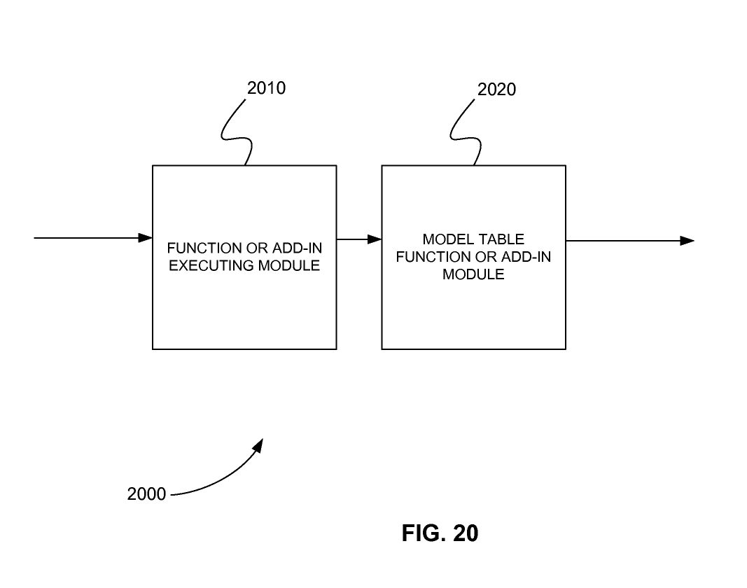

FIG. 20 is a schematic diagram of a system 2000 that includes one or more distinct software modules that performs a method for automatically generating a model table that has more than two data dimensions in a spreadsheet program by selecting the more than two data dimensions from two or more tables of the spreadsheet program, in accordance with various embodiments. System 2000 includes function or add-in executing module 2010 and model table function or add-in module 2020.

Function or add-in executing module 2010 executes a model table function or add-in as part of a spreadsheet program after receiving from a pointing and selection device an indication that a selection item of the spreadsheet program displayed on a display device for the model table function or add-in is selected.

Model table function or add-in module 2020 receives from the pointing and selection device more than two selections of one or more rows or columns from two or more tables of the spreadsheet program displayed on the display device. Each selection of the more than two selections represents a different data dimension of more than two different data dimensions selected from the two or more tables. Model table function or add-in module 2020 generates a model table with more than two data dimensions in the spreadsheet program from the more than two different data dimensions selected from the two or more tables by automatically repeating the elements of at least one data dimension of the more than two different data dimensions.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for automatically generating a model table that has more than two data dimensions in a spreadsheet program by selecting the more than two data dimensions from two or more tables of the spreadsheet program, comprising:
a display device that displays one or more row and column cells of one or more spreadsheets of a spreadsheet program;
a pointing and selection device that allows the selection of one or more row cells or one or more column cells of the one or more spreadsheets; and
a processor in communication with the display device and the pointing and selection device that executes the spreadsheet program and that
executes a model table function or add-in as part of the spreadsheet program after receiving from the pointing and selection device an indication that a selection item of the spreadsheet program displayed on the display device for the model table function or add-in is selected,
receives from the pointing and selection device, using the model table function or add-in, more than two selections of one or more rows or columns from two or more tables of the spreadsheet program displayed on the display device, wherein each selection of the more than two selections represents a different data dimension of more than two different data dimensions selected from the two or more tables, and
generates, using the model table function or add-in, a model table with more than two data dimensions in the spreadsheet program from the more than two different data dimensions selected from the two or more tables by automatically repeating the elements of at least one data dimension of the more than two different data dimensions.

2. The system of claim 1, wherein the processor further displays on the display device, using the model table function or add-in, a selection item for importing data for the model table, and imports data for the model table, using the model table function or add-in, when the processor receives from the pointing and selection device, using the model table function or add-in, an indication the selection item for importing data for the model table is selected.

3. The system of claim 1, wherein the processor further displays on the display device, using the model table function or add-in, a selection item for generating random data for the model table, and generates random data for the model table, using the model table function or add-in, when the processor receives from the pointing and selection device, using the model table function or add-in, an indication the selection item for generating random data for the model table is selected.

4. The system of claim 1, wherein the processor further displays on the display device, using the model table function or add-in, a selection item for viewing or reporting data from the model table on the display device as a function of two or more data dimensions of the more than two different data dimensions, and when the processor receives from the pointing and selection device, using the model table function or add-in, an indication the selection item for viewing or reporting data from the model table is selected, generates in the spreadsheet program, using the model table function or add-in, a view table with data from the model table expressed as a function of the two or more data dimensions and displays the view table on the display device.

5. The system of claim 4, wherein the processor further receives from the pointing and selection device, using the model table function or add-in, a change to one or more cells of the view table, and writes back, using the model table function or add-in, the change to the model table.

6. The system of claim 1, wherein when a selection of the more than two selections of one or more rows or columns from two or more tables of the spreadsheet program received from the pointing and selection device includes one row or one column and a value of the one row or column is indented with respect to other values of the one row or one column, the processor further, using the model table function or add-in, creates a hierarchy of the values in the one row or one column and places the value that is indented higher in the hierarchy than the other values.

7. The system of claim 1, wherein when a selection of the more than two selections of one or more rows or columns from two or more tables of the spreadsheet program received from the pointing and selection device includes two rows or two columns, the processor further, using the model table function or add-in, examines the second row or second column for data types of the data related to each data dimension values and stores the datatype with each data dimension value.

8. The system of claim 1, wherein the processor further displays on the display device, using the model table function or add-in, a selection item for entering rules for the model table, and when the processor receives from the pointing and selection device, using the model table function or add-in, an indication the selection item for entering rules is selected, the processor receives from the pointing and selection device, using the model table function or add-in, one or more rules entered and stores, using the model table function or add-in, the one or more rules entered with the model table.

9. A method for automatically generating a model table that has more than two data dimensions in a spreadsheet program by selecting the more than two data dimensions from two or more tables of the spreadsheet program, comprising:
executing a model table function or add-in as part of a spreadsheet program after receiving from a pointing and selection device an indication that a selection item of the spreadsheet program displayed on a display device for the model table function or add-in is selected using a processor;
receiving from the pointing and selection device, using the model table function or add-in, more than two selections of one or more rows or columns from two or more tables of the spreadsheet program displayed on the display device using the processor, wherein each selection of the more than two selections represents a different data dimension of more than two different data dimensions selected from the two or more tables; and
generating, using the model table function or add-in, a model table with more than two data dimensions in the spreadsheet program from the more than two different data dimensions selected from the two or more tables by automatically repeating the elements of at least one data dimension of the more than two different data dimensions using the processor.

10. The method of claim 9, further comprising displaying on the display device, using the model table function or add-in, a selection item for importing data for the model table, and importing data for the model table, using the model table function or add-in, when, using the model table function or add-in, an indication the selection item for importing data for the model table is selected is received from the pointing and selection device using the processor.

11. The method of claim 9, further comprising displaying on the display device, using the model table function or add-in, a selection item for generating random data for the model table, and generating random data for the model table, using the model table function or add-in, when, using the model table function or add-in, an indication the selection item for generating random data for the model table is selected is received from the pointing and selection device using the processor.

12. The method of claim 9, further comprising displaying on the display device, using the model table function or add-in, a selection item for viewing or reporting data from the model table on the display device as a function of two or more data dimensions of the more than two different data dimensions, and when, using the model table function or add-in, an indication the selection item for viewing or reporting data from the model table is selected is received from the pointing and selection device, generating in the spreadsheet program, using the model table function or add-in, a view table with data from the model table expressed as a function of the two or more data dimensions and displaying the view table on the display device using the processor.

13. The method of claim 12, further comprising receiving from the pointing and selection device, using the model table function or add-in, a change to one or more cells of the view table, and writing back, using the model table function or add-in, the change to the model table using the processor.

14. The method of claim 9, further comprising displaying on the display device, using the model table function or add-in, a selection item for entering rules for the model table, and when, using the model table function or add-in, an indication the selection item for entering rules is selected is received from the pointing and selection device, receiving from the pointing and selection device, using the model table function or add-in, one or more rules entered and storing, using the model table function or add-in, the one or more rules entered them with the model table using the processor.

15. A computer program product, comprising a non-transitory and tangible computer-readable storage medium whose contents include a program with instructions being executed on a processor so as to perform a method for automatically generating a model table that has more than two data dimensions in a spreadsheet program by selecting the more than two data dimensions from two or more tables of the spreadsheet program, comprising:
providing a system, wherein the system comprises one or more distinct software modules, and wherein the distinct software modules comprise a function or add-in executing module and a model table function or add-in module;
executing a model table function or add-in as part of a spreadsheet program after receiving from a pointing and selection device an indication that a selection item of the spreadsheet program displayed on a display device for the model table function or add-in is selected using the function or add-in executing module;
receiving from the pointing and selection device more than two selections of one or more rows or columns from two or more tables of the spreadsheet program displayed on the display device using the model table function or add-in module, wherein each selection of the more than two selections represents a different data dimension of more than two different data dimensions selected from the two or more tables; and
generating a model table with more than two data dimensions in the spreadsheet program from the more than two different data dimensions selected from the two or more tables by automatically repeating the elements of at least one data dimension of the more than two different data dimensions using the model table function or add-in module.
